(19) United States
(12) Patent Application Publication
(10) Pub. No.: US 2005/0267769 A1
(43) Pub. Date: Dec. 1, 2005

(54) Method of development of business-management simulation system

(75) Inventor: Si-Liang Lin, Taipei (TW)

Correspondence Address: DENNISON, SCHULTZ, DOUGHERTY & MACDONALD, SUITE 105, 1727 KING STREET, ALEXANDRIA, VA, 22314-2700, US

(73) Assignee: TOP-BOSS INTERNATIONAL CO., LTD.

(21) Appl. No.: 10/854,224

(22) Filed: May 27, 2004

(51) Int. Cl. G06F 17/60

(52) U.S. Cl. 705/1; 705/10

(57) ABSTRACT

The present invention is related to a method of development of a business-management simulation system, it includes an analysis module for business-management simulation, an interpretive module for business-management simulation and a control interface-module for management simulation. The method can fast develop the business-management simulation system by setting or changing a business-management model of the analysis module for business-management simulation and a message of circumstance parameter, as well as setting or changing a message of business parameter of the interpretive module for business-management simulation. Therefore, the method suits development of a business-management simulation system of a general industry or a specific industry.

### BACKGROUND OF THE INVENTION

1. Field of the Invention

The present invention is related to a method of development of a business-management simulation system, and especially to a method of development of a business-management simulation system in a modularization mode with a business-management simulation interpretive module. The method can fast develop a business-management simulation system by setting and changing specific elements in the module; it suits development of a business-management simulation system of a general industry or a specific industry.

2. Description of the Prior Art

In order to win in violent competitions of commercial activities, many enterprises must pay very expensive cost of learning and get through procedures of trying that are time consuming and energy exhausting to find their most suitable commercial strategies. And early before getting their goal, many enterprises close their life of business on the long and endless road of competition. Following development of information technology, people started to use the information technology to assist to fast and easily build and increase their competitive power of enterprise in various ways, in which using a business-management simulation system is the most effective way.

A business-management simulation system is for creating a circumstance of commercial competition of an enterprise and those problems generated and derived in management of the enterprise through simulating the real situation of management of the enterprise. By use and learning of users, and even by mutual competition, learners are trained to analyze the information of environment, to deal with the mass relationship and to decide a policy, thereby to strengthen the commercial competitive ability of the enterprise.

There are a lot of advantages in using such a business-management simulation system; not only the system can create the quasi-real circumstance of learning for the enterprise to make the learning goal of a user clear and definite, but also the system is rich in challenging and provides a dynamic learning environment to allow interaction among learners to quickly feed back the achievement of learning and to foster the ability of figure analysis as well as rational judgment; and such a business-management simulation system gives the function of playing roles, a user can foster the ability of joining in policy decision of an enterprise, and can be effectively helped to build up a whole conception in operation of the enterprise as well as a commercial strategy.

Such a business-management simulation system has a very wide scope of application, for example, a course of strategic theory opened in a Chicago Divisional School of Illinois University of the U.S.A. combines the practical experiences in the markets and the correct theoretical basis by using IMPARTA strategic theory system, the course uses cartoon animations and humorous expressing measures to make learners easy in learning and remembering. Other examples are the business-management simulation games vended in the markets, including “Airline Tycoon”, “Railroad Tycoon” and “Patrizier” etc.

However, the scopes of commercial activity and class are extremely wide, every industry has its professional knowledge and industrial feature, and leads that in investing and developing business-management simulation systems for different industries, extreme expensive and large manpower, amount of material and time are often required to cast in, so that a suite of embryonic form of business-management simulation system can only be developed suiting a specific business; plus testing, using, correcting as well as maintenance in quite a long time, the suite of business-management simulation system can then be given birth to smoothly.

Therefore, the time schedule and investment source in development of such a business-management simulation system generally is a key point that must be put in consideration. However, modern commercial activities go with fast paces and emphasizing of time efficiency; only a suite of embryonic form of business-management simulation system that can simulate actual business managing state in a short time and can flexibly adjust the condition of management of a specific industry is able to satisfy the requirement of enterprises.

Therefore, some businessmen figure out the mode of modularizing suites of programs of development to speed up development of business-management simulation systems, so that different program modules can be mutually combined according to the styles of business management of specific industries to achieve development of all the business-management simulation systems. While the way of development of such a business-management simulation system has fixed styles as to setting of specific elements and setting of the conditions for parameters of the specific elements, and relies on specific persons, so that it is restrained by limited agility, and is unable to really effectively reduce the time of development of the system or increase the entire efficiency of development to surely satisfy the requirement of development of the system.

The conventional method in development of a business-management simulation system thereby has the defects below:
1. It is unable to modularize the development of the business-management simulation system, and can only to develop sequentially according to the specific style of and the parameters of business management to be simulated; once the specific style of and the parameters of business management to be simulated need to be changed, the time for development will be delayed as to a state of smaller seriousness, and the operation of development shall be restarted as to a state of larger seriousness, these can both seriously affect the cost of development of the business-management simulation system.
2. Even when the business-management simulation system is to be developed in a modularization mode, still only the specific elements and the conditions of environment of the specific style of business management to be simulated can be set in pursuance of the specific mode of management of the specific industry, the specific elements and the conditions of environment of the specific style of business-management to be simulated can not be flexibly increased/decreased; otherwise, difficulty for increasing/decreasing of the specific elements and the conditions of environment of the specific style of business management to be simulated is extremely high. These not only very mush limit the reality, agility and flexibility of the style of business-management to be simulated, but also make the development of the business-management simulation system time consuming and energy exhausting, thereby such modularization does not have the value of economic effect.
3. The business-management simulation system acquired by development does not have the function of iterative authoring and version management, a system manager and the subsequent developers are unable to effectively handle various versions of development, and this is subjected to inducing blind spots of system maintenance and improvement.

In view of the above defects to be solved for providing a new way to fast develop a business-management simulation system that can be flexibly adjusted, the inventor provides the present invention based on his professional experience of years in combination with practical operations, theoretical design and planning, and through nonstop studying and improvement.

### SUMMARY OF THE INVENTION

The primary object of the present invention is to provide a method of developing a business-management simulation system in a modularization mode, and especially a method with a business-management simulation interpretive module to fast develop a business-management simulation system by setting and changing specific elements in the module; it suits development of a business-management simulation system of a general industry or a specific industry.

To achieve the above object, the business-management simulation system of the present invention includes an analysis module for business-management simulation, an interpretive module for business-management simulation and a control interface-module for management simulation. The analysis module for business-management simulation includes a content processing unit for business-management simulation, a circumstance creating unit for business-management simulation and a message processing unit; the interpretive module for business-management simulation includes a business-parameter operational unit and an interpretive unit; the control interface-module for management simulation includes a controlling and processing unit for management simulation and an I/O interface unit.

When in developing the business-management simulation system, the steps include:
(a) the circumstance creating unit for business-management simulation sets a message of circumstance parameter according to a business-management model of the content processing unit for business-management simulation; and
(b) the business-parameter operational unit and the I/O interface unit are set to respectively have the specific elements in corresponding to the content for business-management simulation of the content processing unit for business-management simulation.

Therefore, when the content for business-management simulation of the content processing unit for business-management simulation and the message of business parameter of the business-parameter operational unit have been finished in setting, development of the business simulation system can be completed in accompaniment.

The present invention will be apparent after reading the detailed description of the preferred embodiment thereof in reference to the accompanying drawings.

### BRIEF DESCRIPTION OF THE DRAWINGS

FIG. 1 is a view showing the systematic skeleton of an embodiment of the present invention;

FIG. 2 is a flow chart showing the steps for developing the system of the present invention;

FIG. 3 is a flow chart showing the steps for executing the system of the present invention;

FIG. 4 is a flow chart showing the steps of the present invention for simulated managing of an industry in a different environment;

FIG. 5 is a view showing the system of an application embodiment of the present invention.

### DETAILED DESCRIPTION OF THE PREFERRED EMBODIMENT

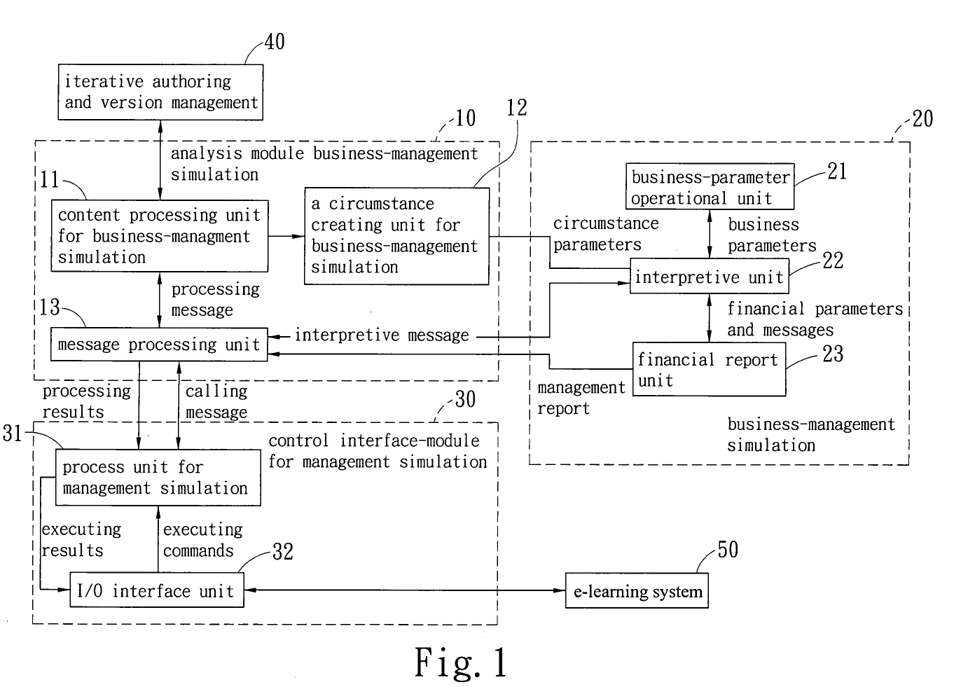

Referring firstly to FIG. 1, the method of development of a business-management simulation system of the present invention includes an analysis module for business-management simulation 10, an interpretive module for business-management simulation 20 and a control interface-module for management simulation 30. The analysis module for business-management simulation 10 includes a content processing unit for business-management simulation 11, a circumstance creating unit for business-management simulation 12 and a message processing unit 13; the interpretive module for business-management simulation 20 includes a business-parameter operational unit 21 and an interpretive unit 22; the control interface-module for management simulation 30 includes a controlling and processing unit for management simulation 31 and an I/O interface unit 32.

The content processing unit for business-management simulation 11 further is connected with a business-management-simulation iterative authoring and version management system 40 able for managing the contents of business-management simulation of various editions. The interpretive module for business-management simulation 20 further includes a financial report unit 23 to provide a message of financial reports of the business-management simulation. And the I/O interface unit 32 can further be connected with an e-learning system 50 for mutually delivering the interface message of management simulation.

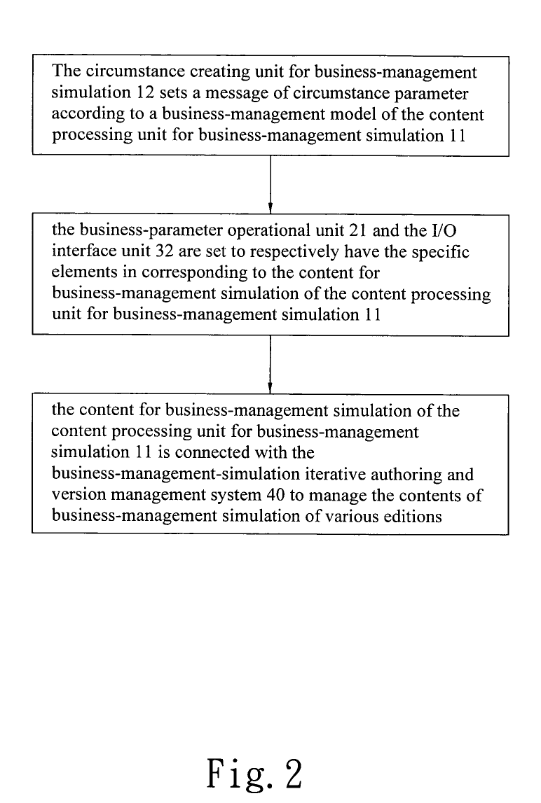

When in developing the business-management simulation system, the steps for developing are as shown in FIG. 2 and include:
(a) the circumstance creating unit for business-management simulation 12 sets a message of circumstance parameter according to a business-management model of the content processing unit for business-management simulation 11; and
(b) the business-parameter operational unit 21 and the I/O interface unit 32 are set to respectively have the specific elements in corresponding to the content for business-management simulation of the content processing unit for business-management simulation 11.

Therefore, when the content for business-management simulation of the content processing unit for business-management simulation 11, the message of business parameter of the business-parameter operational unit 21 and the I/O interface unit 32 of the specific elements of the content for business-management simulation have been finished their setting, development of the business simulation system can be completed in accompaniment. The content processing unit for business-management simulation 11 further is connected with the business-management-simulation iterative authoring and version management system 40 to manage the contents of business-management simulation of various editions.

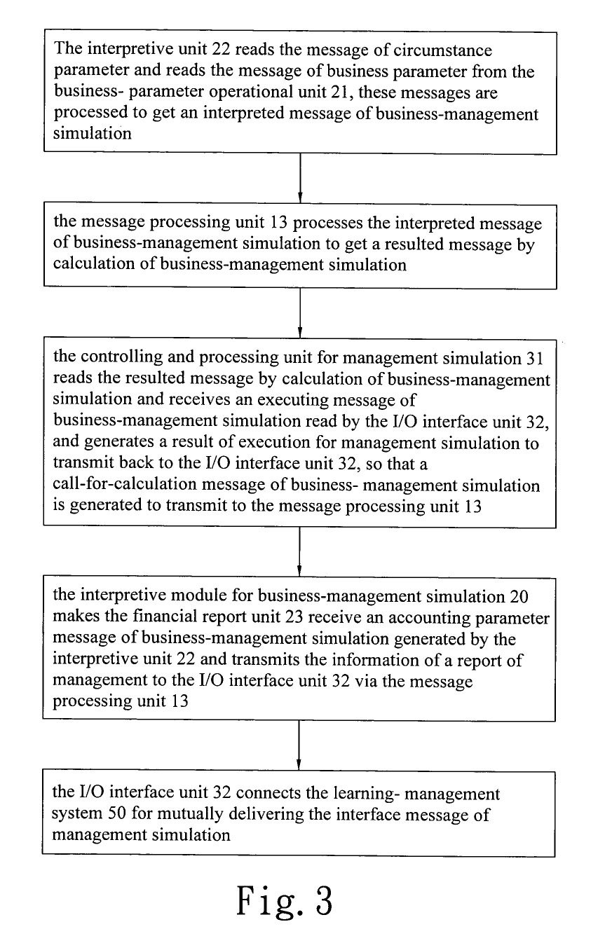

After developing the business-management simulation system, the steps for executing are as shown in FIG. 3 and include:
(a) the interpretive unit 22 reads the message of circumstance parameter and reads the message of business parameter from the business-parameter operational unit 21, these messages are processed to get an interpreted message of business-management simulation;
(b) the message processing unit 13 processes the interpreted message of business-management simulation to get a resulted message by calculation of business-management simulation;
(c) the controlling and processing unit for management simulation 31 reads the resulted message by calculation of business-management simulation and receives an executing message of business-management simulation read by the I/O interface unit 32, and generates a result of execution for management simulation to transmit back to the I/O interface unit 32, so that a call-for-calculation message of business-management simulation is generated to transmit to the message processing unit 13.

In this way, when in simulating management of a specific industry, a user can experience various situations of business management of the specific industry quite truly according to the message of the specific industry provided from the content for business-management simulation of the content processing unit for business-management simulation 11 and the message of business parameter of the business-parameter operational unit 21. In the mean time, different users can also experience truer and more multi-factorial situations of management simulation by competition during such simulating.

The interpretive module for business-management simulation 20 further includes the financial report unit 23, and the financial report unit 23 receives an accounting parameter message of business-management simulation generated by the interpretive unit 22 and transmits the information of a report of management to the I/O interface unit 32 via the message processing unit 13. The I/O interface unit 32 can further be connected with the e-learning system 50 for mutually delivering the interface message of management simulation.

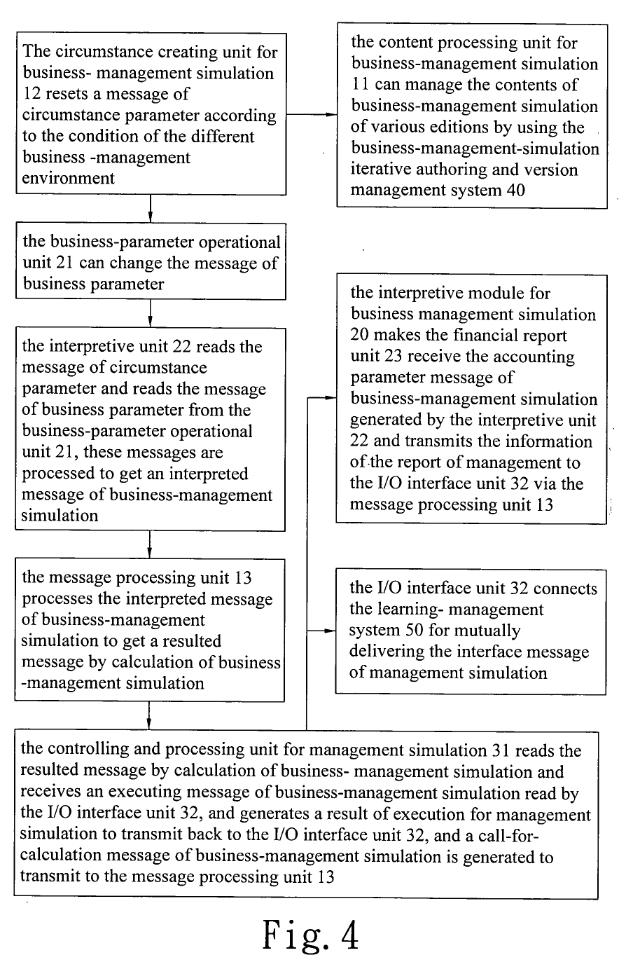

When the above stated developed business-management simulation system is executed in a different business-management environment of the same industry, the steps for executing are as shown in FIG. 4 and include:
(a) the circumstance creating unit for business-management simulation 12 resets a message of circumstance parameter according to the condition of the different business-management environment;
(b) the business-parameter operational unit 21 can change the message of business parameter;
(c) the interpretive unit 22 reads the message of circumstance parameter and reads the message of business parameter from the business-parameter operational unit 21, these messages are processed to get an interpreted message of business-management simulation;
(d) the message processing unit 13 processes the interpreted message of business-management simulation to get a resulted message by calculation of business-management simulation;
(e) the controlling and processing unit for management simulation 31 reads the resulted message by calculation of business-management simulation and receives an executing message of business-management simulation read by the I/O interface unit 32, and generates a result of execution for management simulation to transmit back to the I/O interface unit 32, and a call-for-calculation message of business-management simulation is generated to transmit to the message processing unit 13.

Thereby, to simulate managing a different business-management environment of the same industry, it needs only to change the message of circumstance parameter of the circumstance creating unit for business-management simulation 12 and the message of business parameter of the business-parameter operational unit 21 to easily adjust and change the business-management environment of the business-management simulation system. And the content processing unit for business-management simulation 11 can manage the contents of business-management simulation of various editions by using the business-management-simulation iterative authoring and version management system 40.

The interpretive module for business-management simulation 20 further includes the financial report unit 23 which receives the accounting parameter message of business-management simulation generated by the interpretive unit 22 and transmits the information of the report of management to the I/O interface unit 32 via the message processing unit 13. The I/O interface unit 32 can further be connected with the e-learning system 50 for mutually delivering the interface message of management simulation.

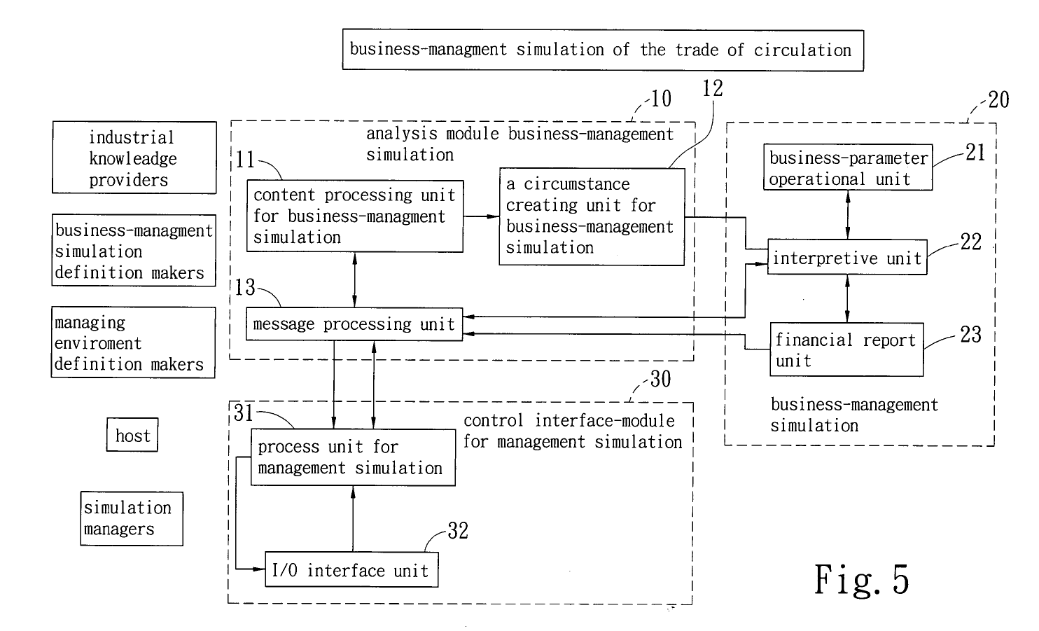

Referring to FIG. 5, the figure shows an embodiment in application of the present invention for developing and executing business-management simulation of the trade of circulation. When in development, an expert of the trade of circulation provides the professional know-how and experience for the content processing unit for business-management simulation 11, and a business-model definition maker does the model analysis and building using the circumstance creating unit for business-management simulation 12, thereby the model of management and the model elements of the trade of circulation can be defined and built. According to the model of management and the model elements of the trade of circulation, the message of circumstance parameter of the trade of circulation then is provided for the circumstance creating unit for business-management simulation 12, the message of business parameter is provided for the business-parameter operational unit 21, and the I/O interface unit 32 used by a manager of simulation.

In executing, a managing-environment definition maker sets a specific message of circumstance parameter in the business-parameter operational unit 21, and a group of managers of simulation of different backgrounds get together to make several fabricated enterprises, they compete violently through the I/O interface unit 32 under the simulated industrial environment set by a management simulation chairman with a goal to try hard in pursuing the largest profits in a sustained mode. The managers of simulation can take the respectively divisional jobs of various departments, and carefully analyze that all the possible data come from inside and outside of the enterprises, and various formal and informal information to make their own judgment. Lastly, they go through a procedure of making policies by repeatedly making continuous discussions, negotiations, meetings and coordination to obtain policy values in a set of figures or literal expressions; they put the policies of their companies into the industrial environment; and in the mutual competition, the situation of the markets changes immediately, gains and losses of the enterprises appear instantly, on the expectation that they do their best to keep or improve the present superior or inferior positions in the markets, the second-time procedure of making policies starts, and these run again and again; at last, the management simulation chairman determines their achievements and efficiencies according to the standard of victory and defeat or their rates of reward of investments.

Therefore, the present invention has the following advantages:
1. to flexibly and authentically simulate the modes of management of various industries: the present invention can analyze and build business-management simulations of different industries, and accordingly set the elements of related business-management simulations as well as provide the message of parameter of the related industries and provide the utility interface suitable for managers in simulation;
2. to reduce the cost of the development of a business-management simulation system: to fast develop a desired business-management simulation system by setting the business model, defining a message of circumstance parameter for business-management simulation and providing a message of business parameter, in order to effectively reduce the cost of manpower, the amount of material and time etc.;
3. to effectively handle connection among various versions of development through a business-management-simulation iterative authoring and version management system, and to make the simulation managers obtain better simulation experience through a I/O interface unit 32 and an e-learning system.

In conclusion, according to the description disclosed above, the present invention surely can get the expected object thereof to provide a method of development a business-management simulation system in a modularization mode. The method can fast develop a business-management simulation system by setting and changing specific elements in a module; it suits development of a business-management simulation system of a general industry or a specific industry

1. A method of development of a business-management simulation system includes using an analysis module for business-management simulation, an interpretive module for business-management simulation and a control interface-module for management simulation; said analysis module for business-management simulation includes a content processing unit for business-management simulation, a circumstance creating unit for business-management simulation and a message processing unit; said interpretive module for business-management simulation includes a business-parameter operational unit and an interpretive unit; said control interface-module for management simulation includes a controlling and processing unit for management simulation and an I/O interface unit; said method uses the above modules and units to execute the steps including:
(a) said circumstance creating unit for business-management simulation sets a message of circumstance parameter according to a business-management model of said content processing unit for business-management simulation; and
(b) said business-parameter operational unit and said I/O interface unit are set to respectively have specific elements in corresponding to the content for business-management simulation of said content processing unit for business-management simulation;
therefore, when said content for business-management simulation of said content processing unit for business-management simulation and a message of business parameter of said business-parameter operational unit have been finished in setting, development of said business simulation system is completed in accompaniment.

2. The method of development of a business-management simulation system as in claim 1, wherein after developing said business-management simulation system, the steps for executing in using include:
(c) said interpretive unit reads said message of circumstance parameter and reads said message of business parameter from said business-parameter operational unit, said messages are processed to get an interpreted message of business-management simulation;
(d) said message processing unit processes said interpreted message of business-management simulation to get a resulted message by calculation of business-management simulation;
(e) said controlling and processing unit for management simulation reads said resulted message by calculation of business-management simulation and receives an executing message of business-management simulation read by said I/O interface unit, and generates a result of execution for management simulation to transmit back to said I/O interface unit, so that a call-for-calculation message of business-management simulation is generated to transmit to said message processing unit.

3. The method of development of a business-management simulation system as in claim 1, wherein said interpretive module for business-management simulation further includes a financial report unit to receive an accounting parameter message of business-management simulation generated by said interpretive unit and transmits information of a report of management to said I/O interface unit via said message processing unit.

4. The method of development of a business-management simulation system as in claim 1, wherein said content processing unit for business-management simulation further is connected with a business-management-simulation iterative authoring and version management system to manage said content of business-management simulation.

5. The method of development of a business-management simulation system as in claim 1, wherein said I/O interface unit further is connected with an e-learning system for mutually delivering an interface message of management simulation.
